(19) United States
(12) Patent Application Publication
(10) Pub. No.: US 2006/0000101 A1
(43) Pub. Date: Jan. 5, 2006

(54) Measurement probe for profilometer and method for manufacturing same

(75) Inventors: Takeo Nakagawa, Tokyo (JP); Qing Liu, ShenZhen (CN); De-Cheng Chen, ShenZhen (CN)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/170,533

(22) Filed: Jun. 29, 2005

(30) Foreign Application Priority Data
Jul. 2, 2004 (CN) 200410027980.0

(51) Int. Cl. G01B 5/004

(52) U.S. Cl. 33/559

(57) ABSTRACT

A probe (30) for use in surface measurement equipment such as a profilometer. The probe includes a holder (32), a head member (35), and a connecting member (37). The connecting member has a first end and a second end. The holder has a first recess (33) at one end thereof for receiving the first end of the connecting member. The head member has a second recess spanning from an outer surface to a central portion thereof for receiving the second end of the connecting member. The first end of the connecting member has a similar shape to the first recess of the holder and is fixed in first recess by adhering, welding or doweling. The second end of the connecting member has a similar shape to the second recess of the head member and is fixed in the second recess by adhering or welding.

### FIELD OF THE INVENTION

The present invention relates to surface measurement equipment such as a profilometer which measures surface profiles with high precision, and more particularly to a probe structure used for a profilometer and method for manufacturing the probe structure.

### BACKGROUND

Measurement of surface topography or surface roughness is very important in manufacturing of small sized products such as optical lenses used in optical communication, pickup lenses for optical disks, and molds for making such lenses. Generally, methods for measuring surface topography include the contact mode measurement method and the non-contact mode measurement method. The contact mode measurement method detects a surface of an object being measured by contacting a probe of a piece of measurement equipment (such as a profilometer, also named a profiler) with the surface of the object, and moving the probe along the surface at a predetermined velocity to obtain data pertaining to the surface. Generally, a contact-type profiler employs a probe having a tip end moving along the surface being measured. Unevenness of the surface causes the probe to move up and down, and these displacements are converted into optical or electrical signals. Then the signals are magnified and processed by a computer to obtain a trace of the profile or surface roughness of the surface measured.

One important factor affecting the precision of contact-type profilometers is the geometrical shape and size of the probe, especially the shape and size of the tip end of the probe that directly contacts the surface to be measured. Generally, a probe employs a spherical tip end, which generally comprises a ruby ball with a very small diameter (for example, less than 1 mm). The smaller the diameter of the tip end, the higher the precision of the profilometer. A relatively large tip end lowers the precision of measurement, and also increases the tolerance, i.e., the difference between the true value and the measured value. The theoretical ideal diameter of the tip end is zero. According to modern technologies, typical diameters of tip ends are in the scale of micrometers. In addition, the higher the roundness of the tip end, the higher the precision of the profilometer.

Besides the tip end, a probe further includes a holder. The holder has a long and narrow shape, and the tip end is fixed on the holder. In general, it is difficult to integrally make a probe having a tip end (such as a ruby ball) with a high roundness. Instead, for a typical probe, the tip end and the holder are first made separately. Then the tip end is attached to the holder to form the unified probe.

In contact-mode measurement equipment such as a profilometer, the probe has to move along a surface of the object to be measured. Hence, the probe needs to satisfy the following requirements:
(1) the tip end of the probe has a small diameter and high roundness in order to improve the measurement precision;
(2) the tip end is firmly jointed with the holder in order to prevent separation; and
(3) the tip end of the probe protrudes sufficiently outward, in order to maximize the effective contact surface of the tip end.

Referring to FIG. 2, a conventional probe 10 for measurement equipment includes a tube member 12, and a sphere member 15 attached to the tube member 12. The tube member 12 and the sphere member 15 are manufactured separately. The tube member 12 is hollow, defining an inner channel 13 therein. Preferably, the sphere member 15 has a high roundness. The sphere member 15 is pressed into the inner channel 13 of the tube member 12 and fixed therein. This means that the sphere member 15 and the tube member 12 have to be made and sized very precisely, so that a diameter of the sphere member 15 mates with a diameter of the inner channel 13. This requirement can significantly increase the difficulty and cost of manufacturing the probe 10. In addition, as seen in FIG. 2, a major portion of the sphere member 15 is received in the channel 13 and covered by the tube member 12, with only ⅓ or less of the surface area of the sphere member 15 being exposed outside the tube member 12. Thus, an effective contact surface of the sphere member 15 for contact with a surface of an object to be measured is limited. If an object having a deep groove or slot is measured, the tube member 12 is liable to contact sidewalls of the groove or slot, thereby preventing the sphere member 15 from reaching the surface in the groove or slot to be measured.

Referring to FIG. 3, another conventional probe 20 includes a tube member 22 and a sphere member 25. The tube member 22 defines an inner channel 23 therein, and the sphere member 25 is adhered on an end of the tube member 22 by an adhesive 26. The probe 20 has the advantage of a major surface portion (greater than ½) of the sphere member 25 being exposed as an effective contact surface. However, adhesion provided by the adhesive 26 is limited, because an adhesive interface area between the sphere member 25 and the channel 23 is relatively small. Hence, the sphere member 25 is liable to separate from the tube member 22, especially when an object being measured has a rough surface. In particular, the sphere member 25 is likely to sustain transverse forces until it detaches from the tube member 22.

Accordingly, what is needed is a probe structure for a profilometer which overcomes the above disadvantages. In particular, a probe which has high measurement precision and improved structural stability.

### SUMMARY

One embodiment of the present invention provides a probe for use in surface measurement equipment such as a profilometer. The probe comprises a holder, a head member, and a connecting member connecting with the holder and the head member respectively. The connecting member has a first end and a second end. The holder has a first recess at one end thereof for receiving the first end of the connecting member. The head member has a second recess spanning from an outer surface to a central portion thereof for receiving the second end of the connecting member. The first end of the connecting member defines a shape similar to that of the first recess of the holder and is fixed in first recess by adhering, welding or doweling. The second end of the connecting member defines a shape similar to that of the second recess of the head member and is fixed in the second recess by adhering or welding. Hence, the head member of the probe is jointed with the holder via the connecting member firmly and stably, and an effective contact surface of the head member is increased for contacting with an object to be measured. In addition, most transverse resist forces produced in use is absorbed by the connecting member, therefore the problem of separation or disconnection of the head member from the holder is avoided.

A method for making the probe comprises steps of: making a holder defining a first recess at one end thereof; making a head member defining a second recess spanning from an outer surface of the head member to a central portion of the head member; making a connecting member having a first end and a second end; fixing the first end of the connecting member in the first recess; and fixing the second end of the connecting member in the second recess.

Other structures, methods, features, and advantages of the present invention will be or become apparent to one skilled in the art upon examination of the following drawings and detailed description. It is intended that all such additional structures, methods, features, and advantages be included within this description, be within the scope of the present invention, and be protected by the accompanying claims.

### BRIEF DESCRIPTION OF THE DRAWINGS

FIG. 1 is a cross-sectional view of a probe according to a preferred embodiment of the present invention;

FIG. 2 is a cross-sectional view of a first conventional probe structure; and

FIG. 3 is a schematic, cross-sectional view of a second conventional probe structure.

### DETAILED DESCRIPTION OF THE PREFERRED EMBODIMENTS

Reference will now be made to the drawings to describe a preferred embodiment of the present invention in detail.

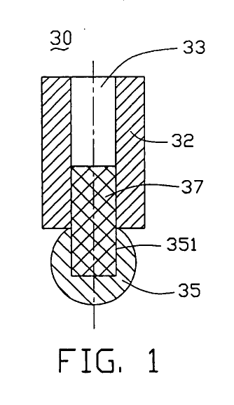

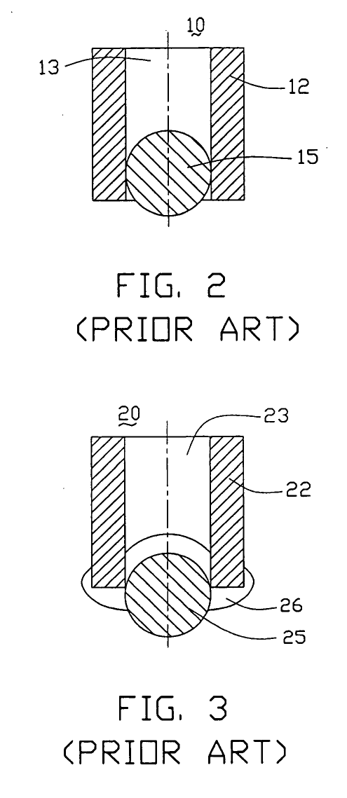

Referring to FIG. 1, according to a preferred embodiment of the present invention, a probe 30 is for use in high precision surface measurement equipment such as a profilometer. The probe 30 includes a holder 32, a head member 35, and a connecting member like a dowel 37 having a first end and an opposite second end. Preferably, the holder 32 is a tubular piece. The holder 32 defines a first recess 33 at one end thereof, for receiving the first end of the dowel 37. The first recess 33 has a configuration similar to that of the first end of the dowel 37. Preferably, the first recess 33 of the holder 32 is shaped as a cylinder, and has a diameter the same as or a little greater than that of the first end of the dowel 37. The head member 35 is a spherical piece, and defines a second recess 351 therein for receiving the second end of the dowel 37. The second recess 351 spans from an outer surface of the head member 35 to a central portion thereof, and has a shape similar to that of the second end of the dowel 37. A diameter of the second recess 351 is the same as or a little greater than that of the second end of the dowel 37. Preferably the head member 35 has a high roundness, and typically has a diameter in the range from a plurality of micrometers to a plurality of millimeters. The dowel 37 is preferably shaped as a cylinder, and has a diameter the same as or a little greater than that of the first recess 33 of the holder 32. A length of the dowel 37 is at least slightly greater than a depth of the second recess 351 of the head member 35. The first end of the dowel 37 is received in the first recess 33 of the holder 32 and fixed therein; for example, by adhering, welding, or interference fitting. The second end of the dowel 37 is received in the second recess 351 of the head member 35 and fixed therein; for example, by adhering or welding.

Preferably, the holder 32 is made of steel, especially tungsten steel, or a super-hard alloy material. The head member 35 may be made of, for example, metal, ruby, ceramic, or a super-hard alloy material. The dowel 37 may be made of metal or a super-hard alloy material.

It is noted that the dowel 37 may instead have other shapes, such as being prism-shaped with one or more triangular cross-sections and/or one or more rectangular cross-sections, or being polygonal. Whatever shape is provided for the dowel 37, the shapes of the first recess 33 of the holder 32 and the second recess 351 of the head member 35 are configured accordingly.

A method for making the probe 30, and advantageous aspects of the present embodiments, will be described below.

The holder 32, dowel 37 and head member 35 are manufactured separately. As an example, the holder 32 and the dowel 37 can be made by an ordinary mechanical machining process. The holder 32 is machined to define the first recess 33 therein, which is then mated with the first end of the dowel 37. The head member 35 is preferably made as a spherical piece having a high roundness. Then the second recess 351 is formed in the head member 35 by a precision machining technology, such as diamond tool milling, grinding, ultrasonic machining, discharge machining, or laser machining.

Then in assembly, the second end of the dowel 37 is inserted into the second recess 351 of the head member 35, and is fixed therein by adhesive or welding. If the dowel 37 is fixed by adhesive, preferably, an adhesive is coated on the second end of the dowel 37 prior to insertion of the second end of the dowel 37 into the second recess 351. After the adhesive is solidified, the dowel 37 and the head member 35 are fixed as one. Because the second end of the dowel 37 is inserted into the head member 35, an adhesive interface are between these two components is significantly increased in comparison with conventional structures. Therefore, a joint strength of and stability between the dowel 37 and the head member 35 are increased. In addition, the dowel 37 takes up minimal space of the outer surface of the head member 35. Therefore an effective contact surface of the head member 35 for contact with an object to be measured is increased. Moreover, in use, a resisting transverse force produced by a rough surface of the object being measured is absorbed by the dowel 37. Hence, the problem of separation or disconnection often occurring in conventional structures is avoided.

Finally, the first end of the dowel 37 is inserted into the first recess 33 of the holder 32, and fixed therein by adhesive, welding, or interference fitting. For reasons similar to those described above, the dowel 37 is firmly jointed with the holder 32, with minimal risk of these two components separating.

The probe 30 as described in the preferred embodiment can be used in various surface measurement equipment, such as a profilometer.

It is believed that the present invention and its advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

We claim:

1. A probe for use in surface measurement equipment, comprising:
a holder defining a first recess at one end thereof;
a head member defining a second recess, the second recess spanning from an outer surface of the head member to a central portion of the head member; and
a connecting member having a first end and an opposite second end, the first end being fixed in the first recess of the holder, and the second end being fixed in the second recess of the head member.

2. The probe as described in claim 1, wherein the first recess defines a shape similar to that of the first end of the connecting member.

3. The probe as described in claim 2, wherein the first recess defines a shape that is cylindrical, prism-shaped with a triangular or a rectangular cross-section, or polygonal.

4. The probe as described in claim 3, wherein a size of the cylinder or the prism is equal to or a little greater than that of the first end of the connecting member.

5. The probe as described in claim 1, wherein the first end of the connecting member is adhered in the first recess.

6. The probe as described in claim 1, wherein the first end of the connecting member is welded or interference fitted in the first recess.

7. The probe as described in claim 1, wherein the second recess of the head member has a shape similar to that of the second end of the connecting member.

8. The probe as described in claim 7, wherein the second recess defines a shape that is cylindrical, prism-shaped with a triangular or a rectangular cross-section, or polygonal.

9. The probe as described in claim 8, wherein a size of the second recess is equal or a little greater than that of the second end of the connecting member.

10. The probe as described in claim 1, wherein the second end of the connecting member is adhered in the second recess.

11. The probe as described in claim 1, wherein the second end of the connecting member is welded in the second recess.

12. The probe as described in claim 1, wherein the head member is spherical, and has a high roundness.

13. The probe as described in claim 1, wherein the head member is made of metal, ruby, ceramic, a super-hard alloy material, or any combination thereof.

14. The probe as described in claim 1, wherein the holder is made of steel, a super-hard alloy material, or any combination thereof.

15. The probe as described in claim 1, wherein the connecting member is made of metal, a super-hard alloy material, or any combination thereof.

16. The probe as described in claim 1, wherein a diameter of the head member is in micrometer or millimeter scale.

17. A method for making a probe for surface measurement equipment, comprising steps of:
making a holder defining a first recess at one end thereof;
making a head member defining a second recess spanning from an outer surface of the head member to a central portion of the head member;
making a connecting member comprising a first end and a second end;
fixing the first end of the connecting member in the first recess; and
fixing the second end of the connecting member in the second recess.

18. The method as described in claim 17, wherein the first end of the connecting member is fixed in the first recess by adhering, welding, or interference fitting.

19. The method as described in claim 17, wherein the second end of the connecting member is fixed in the second recess by adhering or welding.

20. A surface measurement equipment comprising:
a holder of a probe of said equipment;
a head member of said probe defined mostly by round surfaces and disposed next to said holder; and
a connecting member connectively disposed between said holder and said head member for firmly attaching said head member to said holder, at least one end of said connecting member intrusively extending into said head member through surfaces of said head member other than said round surfaces thereof.
